(19) United States
(12) Patent Application Publication
(10) Pub. No.: US 2003/0060926 A1
(43) Pub. Date: Mar. 27, 2003

(54) Dispensing control system

(76) Inventors: Hiroyuki Yuyama, Toyonaka-shi (JP); Yoshito Goto, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/228,077

(22) Filed: Aug. 27, 2002

(30) Foreign Application Priority Data
Aug. 28, 2001 (JP) 2001-257788

(51) Int. Cl. G06F 17/60; G06F 17/00

(52) U.S. Cl. 700/237; 700/236; 705/2; 705/3; 700/241

(57) ABSTRACT

The present invention provides a dispensing control system with which an incompatible prescriptions can be efficiently handled and information about the incompatible prescription and its processing can be effectively used. By a control means 4, whether the prescription data includes incompatible prescription data is detected, the detected incompatible prescription data is allowed to wait and displayed on a display means 1, and processing of the incompatible prescription inputted by an input means 2 is started.

### BACKGROUND OF THE INVENTION

The present invention relates to a dispensing control system for, based on prescription data, controlling dispensing equipment such as an envelope printer, medication dividing and packing machine, injection delivering machine and so forth used in dispensing of medications in medical facilities such as a hospital or the like.

For example, the following are conventionally known as a dispensing control system for controlling dispensing equipment based on prescription data.

Japanese Patent Laid-Open Publication No. 63-117760 discloses a system wherein data from a host computer is assigned to an input device of a dispenser that matches the type of dispensing.

Japanese Patent Laid-Open Publication No. 9-117491 discloses a system wherein descriptions in a prescription are checked about appropriateness of the prescription, and data is printed out when the prescription is inappropriate.

Japanese Patent Laid-Open Publication No. 9-94287 discloses a system wherein a warning is given when a medication contraindicated for the disease of a patient is inputted.

However, in the aforementioned conventional dispensing control systems, even though an incompatible prescription is detected, data is outputted only by printing, warning or the like, and handling and control of the incompatible prescription are put in charge of a pharmacist. Since a pharmacist, particularly an inexperienced pharmacist, requires a long time to determine processing, subsequent prescription is delayed. Furthermore, when each pharmacist determines different processing, responses by physicians or the like become difficult.

Incompatible prescription and its processing are an important information source. If the pharmacist analyzes the contents and provide the information to physicians, improvement of pharmacotherapy can be expected. For example, when a similar prescription becomes an incompatible prescription many times, preventive measures can be taken. Therefore, it is necessary to fully analyze an incompatible prescription and its processing and then utilize the analytical result as valid information. However, since it is difficult for pharmacists to keep a record during busy dispensing work, such information has not been effectively used.

### SUMMARY OF THE INVENTION

Accordingly, an object of the present invention is to provide a dispensing control system with which an incompatible prescription can be efficiently processed and information about the incompatible prescription and its processing can be effectively used.

As a means for achieving the above object, the present invention provides a dispensing control system capable of dispensing a medication by controlling the drive of various dispensing equipment based on prescription data, which includes:

a display means for displaying incompatible prescription data,

an input means capable of inputting processing of the incompatible prescription based on the incompatible prescription data displayed on the display means, and

a control means for detecting whether the prescription data includes incompatible prescription data, allowing the detected incompatible prescription data to wait, displaying the data on the display means, and starting processing of the incompatible prescription inputted by the input means.

Since incompatible prescription data can be detected and its processing can be determined automatically by this constitution, processing of subsequent prescriptions is not delayed and can be smoothly processed.

The aforementioned control means is preferable because, when processing of an incompatible prescription is inputted by the input means, processing of the incompatible prescription is recorded in the storage means, information about the incompatible prescription and its processing can be recorded without labor, and the information about the incompatible prescription and its processing can be analyzed and then provided to physicians.

Furthermore, in the case where the storage means already includes a corresponding record when processing of an incompatible prescription is inputted by the input means, the control means displays the recorded contents to be displayed on the display means so that information about a past incompatible prescription and its processing can be reused or used as reference. Therefore, this control means is preferable since it can provide assistance when an inexperienced pharmacist determines processing.

Furthermore, it is preferable that the dispensing control system further includes a sending means for sending incompatible prescription data, judges whether the incompatible prescription is for an inpatient or outpatient based on the prescription data, and, when the prescription is for an inpatient, allows information about the incompatible prescription and its processing to be notified by the sending means so that a pharmacist in charge is automatically notified without labor.

### BRIEF DESCRIPTION OF THE DRAWINGS

Other objects and features of the present invention will become clear from the following detail description with reference to the accompanying drawings in which:

FIG. 1 is a block diagram showing an equipment configuration in a dispensing control system;

FIG. 2 is a block diagram showing an outline of data processing in the dispensing control system;

FIG. 3 is a flow chart showing dispensing control processing;

FIG. 4 is a view showing stored contents of prescription data;

FIG. 5 is a view showing data contents of an incompatible prescription message;

FIG. 6 is a view showing data contents of a processing message;

FIG. 7 is a flow chart showing processing for incompatible prescription management;

FIG. 8 is a view showing a screen of incompatible prescription processing;

FIG. 9 is a view showing a screen of recorded contents of incompatible prescription processing;

FIG. 10 is a view showing stored contents of recorded data of incompatible prescription processing; and

FIG. 11 is a view showing notified data contents of incompatible prescription processing.

### DETAILED DESCRIPTION OF THE PREFERRED EMBODIMENTS

Hereafter, embodiments of the present invention are described with reference to the accompanying drawings.

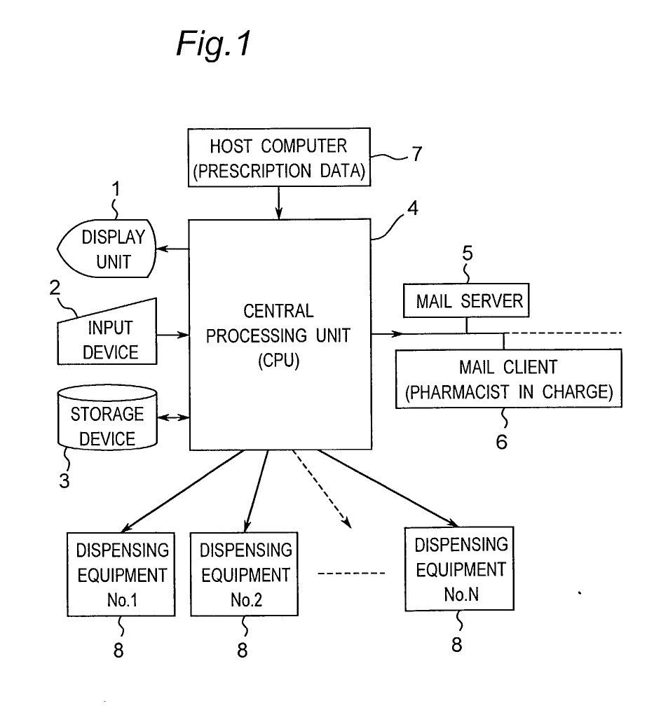

FIG. 1 shows an equipment configuration in a dispensing control system. In order to control input/output, this dispensing control system includes a display device 1 such as a liquid crystal display or the like, an input device 2 such as a keyboard, mouse or the like, a storage device 3 such as a hard disc or the like and a Central Processing Unit (CPU) 4. The system is connected to a mail server 5 and a mail client (pharmacist in charge) 6 via a network so that a message is received from a host computer (prescription data sending device) 7 and that prescription data is inputted from the input device 2 to control dispensing equipment 8 such as an envelope printer, medications dividing and packing machine, injection delivering machine and so forth.

The display device 1 and the input device 2 are used for input/output of prescription data, an incompatible prescription and its processing, data of various masters and so forth, input of operations for the whole dispensing control system and so forth.

The storage device 3 stores various data as databases or files. The various data includes prescription data and various masters. The various masters store related information when prescription data is inputted and basic information of a prescription examination, and include a patient master, medication master, regimen master, department master, physician master, ward master, prescription category master, prescription examination master and so forth (not shown).

The Central Processing Unit (CPU) 4 integrally includes a memory (RAM) for temporarily storing various data, and this memory is used as a prescription data memory for storing prescription data, a work memory for processing and so forth. The Central Processing Unit (CPU) 4 controls programs for the whole dispensing control system.

The display device 1, input device 2, storage device 3 and Central Processing Unit (CPU) 4 may be constituted by personal computers. Furthermore, hardware equipment is not limited to these devices, and the kind and number of devices can be arbitrarily selected.

Furthermore, the host computer 7 is a device having a function of sending prescription data and is connected in an operation where the dispensing equipment 8 is controlled by using the prescription data. In the host computer 7, a prescription ordering system and a medical accounting system of a hospital are operated. However, since prescription data can also be inputted from the input device 2, the host computer 7 is not necessarily required.

Furthermore, the dispensing equipment 8 includes an envelope printer, medication (tablet, powder or solution) dividing and packing machine, powder dispensing and surveying machine, solution dispensing and surveying machine, injection delivering machine and so forth. The kind and number of such machines can be arbitrarily selected.

Furthermore, a client-server system may be configured such that the storage device 3 is an independent database server unit (integrally included in CPU), and that the display device 1, input device 2 and Central Processing Unit (CPU) 4 are connected to the server unit as client terminals via a network (LAN).

Meanwhile, data stored in the storage device 3 includes prescription data, incompatible prescription messages and processing messages.

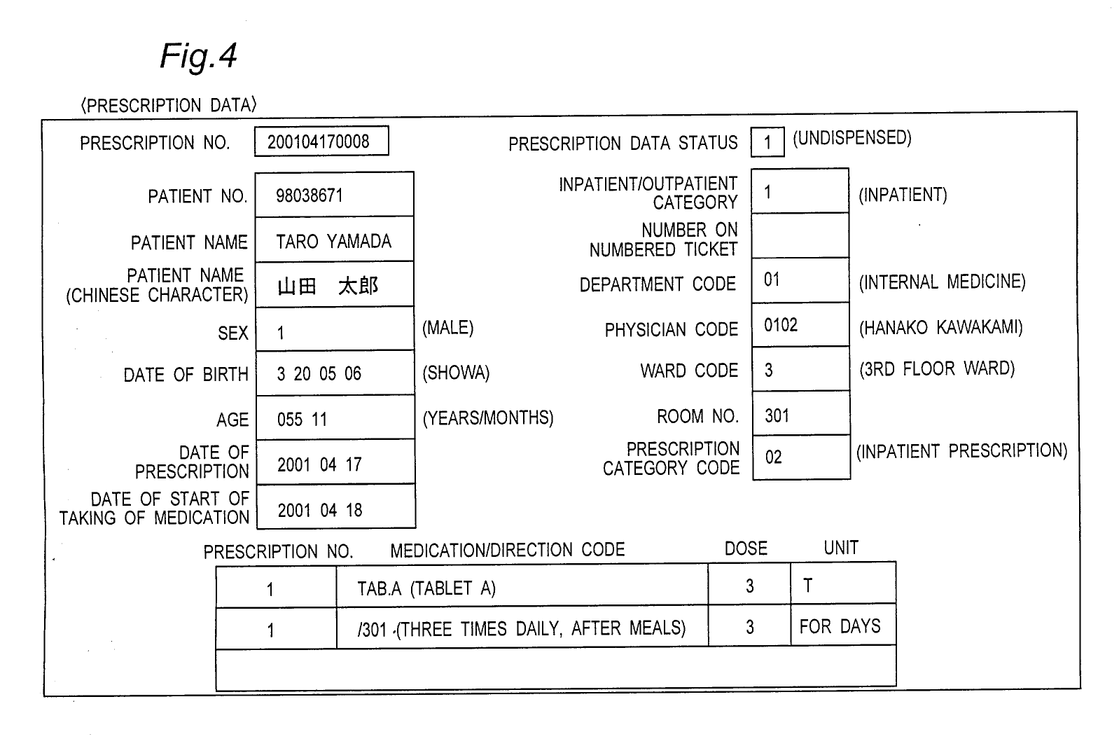

FIG. 4 shows stored contents of one piece of prescription data. All inputted prescription data is stored in the storage device 3 and managed according to prescription numbers and prescription data statuses.

For prescription data for which dispensing can be executed, “undispensed” is set as a prescription data status. For prescription data for which dispensing is allowed to wait, “wait” is set. For prescription data for which dispensing has been executed, “dispensed” is set. For prescription data for which dispensing is not to be executed, “delete” is set. When prescription data is stored and managed, waiting prescription data may be stored and managed individually, for example, depending on the purpose of the prescription data.

Data items in the prescription data include a prescription number (unique number for identifying a prescription), prescription data status (undispensed=1, dispensed=2, wait=3, delete=4), patient number, patient name (kana, Chinese character), sex (male=1, female=2), date of birth (imperial era name: Meiji=1, Taisho=2, Showa=3, Heisei=4), age (years and months), prescription date (date when the physician issues the prescription), start date of taking medicine (day when taking of prescribed mediation is started), inpatient/outpatient (inpatient=1, outpatient=2), number on a numbered ticket (number on a numbered ticket to be exchanged for a medication at an outpatient clinic), department code, physician code, ward code, room number, prescription category code (outpatient prescription=01, inpatient prescription=02), prescription number (serial number of prescription for a set of one or more medications and directions), medication/direction code (example: “TAB.A” is a medication code, and “301” with “/” in front is a direction code), dose (dose of the medication), unit (unit of the medication) and so forth.

It is noted that, when contents of the prescription data are displayed, a name is acquired from each master corresponding to each code to acquire a medication name from a medication master.

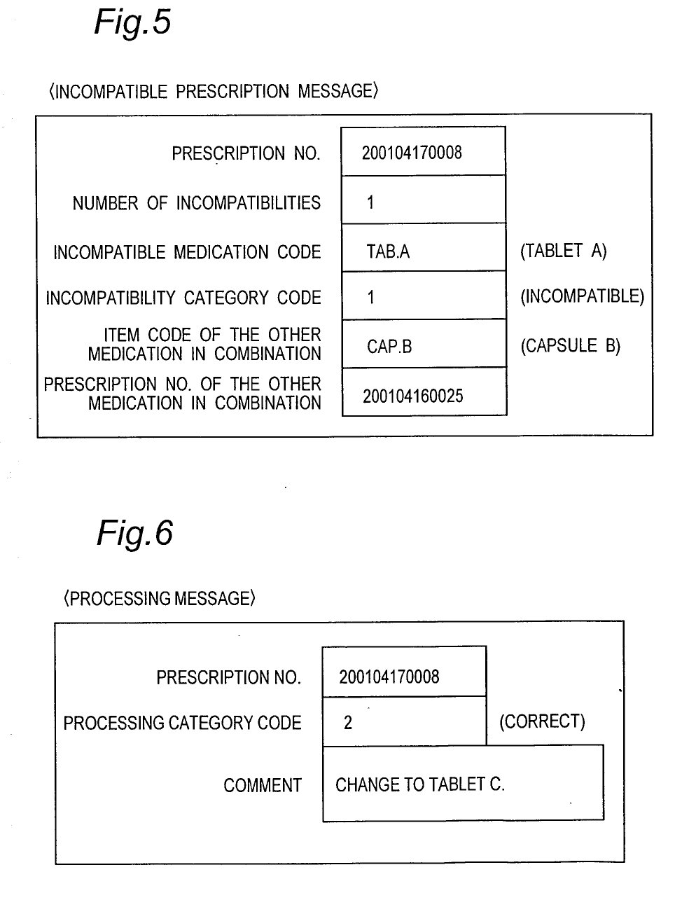

FIG. 5 shows data contents of an incompatible prescription message. In an example shown in FIG. 5, as information of the incompatible prescription, there is one piece of incompatibility data in prescription data with prescription No. “200104170008”. This indicates that a tablet A and a capsule B in prescription data with prescription No. “200104160025” are incompatible. In FIG. 5, the prescription number means a prescription number of an incompatible prescription. The number of incompatibilities means the number of incompatibility data in the incompatible prescription (a set of data consisting of a subsequent incompatible medication code, incompatibility category code, item code of the other medication in combination and prescription number of the other medication in combination). The incompatible medication code means a medication code of an incompatible prescription. The incompatibility category code means a category code of incompatibility (incompatibility=1, contraindication=2 and so forth). The item code for the other medication in combination means an item code of a medication incompatible with this medication (medication code, disease code and so forth). The prescription number for the other medication in combination is a prescription number of a medication incompatible with this medication (null when the incompatibility category is contraindication).

FIG. 6 shows data contents of a processing message. In an example shown in FIG. 6, as processing information of an incompatible prescription, correction of prescription data with prescription No. “200104170008” is indicated with a comment of “change to tablet C”. In FIG. 6, the prescription number means a prescription number of an incompatible prescription to be processed. The processing category code means a category code of processing (stop=1, correct=2, continue=3). The comment means a comment for processing (arbitrary character string).

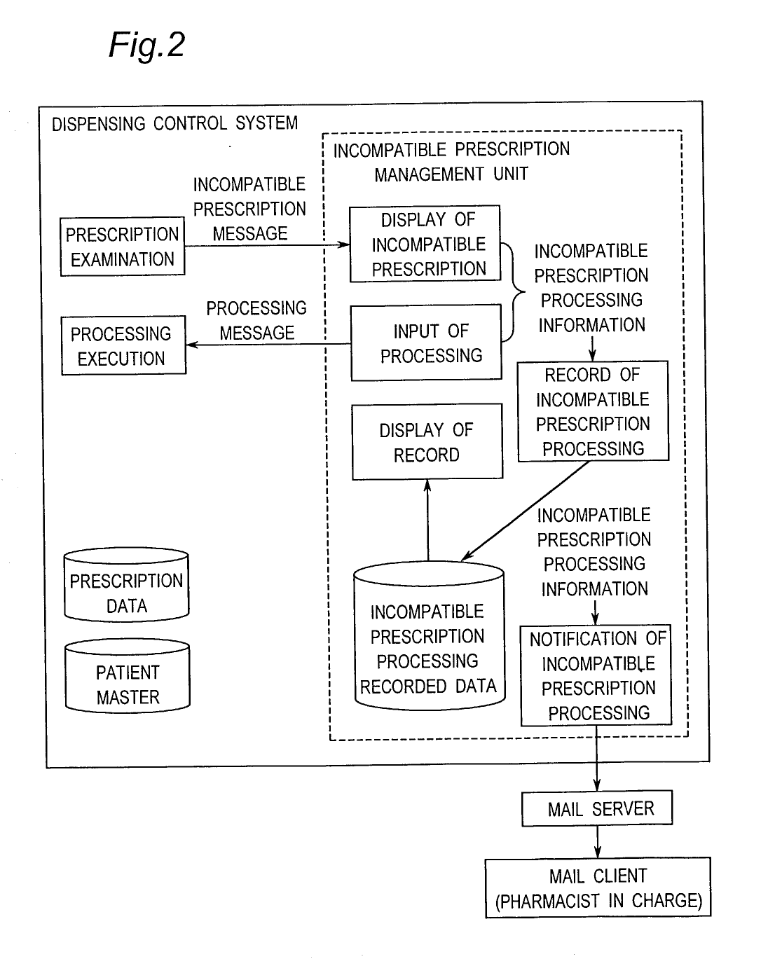

Data processing in the dispensing control system having the aforementioned constitution is described below with reference to a block diagram shown in FIG. 2.

First, in examination of a prescription, when prescription data is examined to detect an incompatible prescription, information of the incompatible prescription is sent as an incompatible prescription message. On an incompatible prescription display of an incompatible prescription management unit, the received information of the incompatible prescription is displayed on a screen. In display of a record, information about a past incompatible prescription and its processing from incompatible prescription processing recorded data is displayed on the screen. A pharmacist determines processing of the incompatible prescription with reference to the information about the past incompatible prescription and its processing. In input of processing, information about the processing determined by the pharmacist is inputted. In recording of incompatible prescription processing, information about the incompatible prescription and its processing is recorded in the incompatible prescription processing recorded data. Furthermore, in input of processing, information about the processing is sent as a processing message, and in execution of processing, the processing of the incompatible prescription is executed according to the received information about the processing. In notification of the incompatible prescription processing, when the incompatible prescription is for an inpatient, information about the incompatible prescription and its processing is notified to a pharmacist in charge as a mail client 6 via the mail server 5. The inputted information about the prescription is stored in the prescription data, and information about a pharmacist in charge of the patient or the like is stored in the patient master.

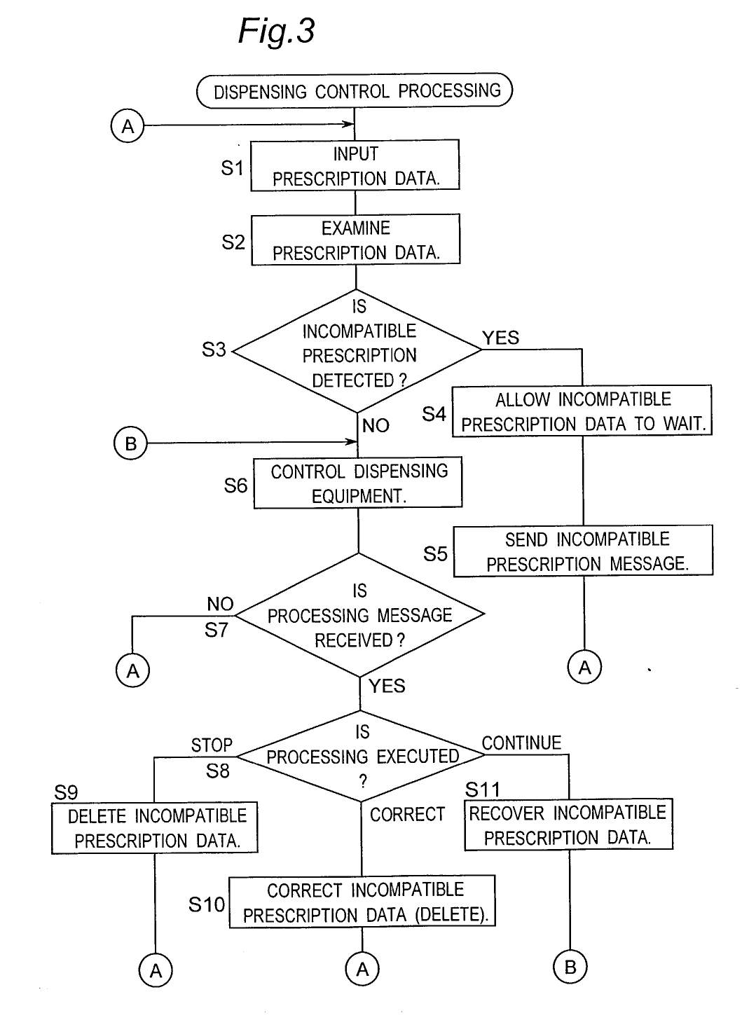

Dispensing control processing in the dispensing control system is described below with reference to a flow chart shown in FIG. 3. This dispensing control processing (FIG. 3) is automatically started at the time of start-up of the system and continues to operate until shutdown of the system.

In dispensing control processing, first, a message is received from the host computer 7, or prescription data (FIG. 4) is inputted by the input device 2 (step S1). The inputted prescription data is provided with a unique prescription number for identification, and “undispensed” is set in the prescription data status and stored in the storage device 3. Then, the inputted prescription data is examined by various checking methods (step S2). Examples of the checking methods include checking of incompatibility about combined use of two or more kinds of medications, checking the disease of the patient (disease name) and contraindications of the medication and so forth, but the checking methods are not limited to these examples. Checking of any of indication, interaction of medications, duplication of medications and so forth may be executed.

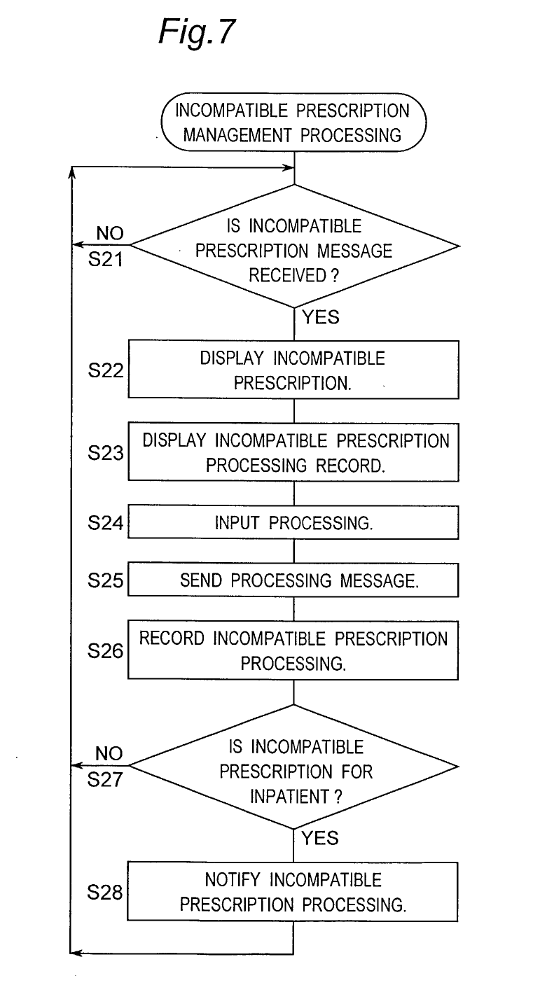

Here, whether the prescription data is an incompatible prescription, for which dispensing cannot be executed, is determined (step S3). If the data is an incompatible prescription, the incompatible prescription data is put in a wait state (step S4). At this time, “wait” is set in the prescription data status in the prescription data (FIG. 4). Then, an incompatible prescription message (FIG. 5) is sent to incompatible prescription management processing (FIG. 7) as information about the incompatible prescription (step S5).

On the other hand, if the data is not an incompatible prescription, operations of the dispensing equipment 8 such as an envelope printer, medication dividing and packing machine, injection delivering machine and so forth are controlled based on the prescription data (step S6). When dispensing is executed, “dispensed” is set in the prescription data status in the prescription data (FIG. 4).

Then, whether a processing message (FIG. 6), which is information about processing, is received from the incompatible prescription management processing (FIG. 7) described later is judged (step S7). If the message is not received, the processing returns to step S1 to repeat the aforementioned processing. If the message is received, whether the category of processing of the processing message (FIG. 6) is stop, correct or continue is judged (step S8).

If the processing category is stop, the waiting incompatible prescription data is put in a delete status (step S9), and the processing proceeds to input of subsequent prescription data. Furthermore, “delete” is set in the prescription data status in the prescription data (FIG. 4). If the processing category is correct, the waiting incompatible prescription data is put in a delete status (step S10). Then, contents of the incompatible prescription data are duplicated so as to be corrected, and the processing proceeds to the input of the subsequent prescription data. However, since input of correction is also performed in the host computer 7 when the prescription data is received from the host computer 7, the waiting incompatible prescription data is put in the delete status, and the processing proceeds to receiving of subsequent prescription data. Furthermore, if the processing category is continue, that is, detection of the incompatible prescription is incorrect, the status of the waiting incompatible prescription data is recovered (step S11), and the processing proceeds to dispensing equipment control to execute dispensing. Furthermore, “undispensed” is set in the prescription data status in the prescription data (FIG. 4).

FIG. 7 shows a flow chart of the incompatible prescription management processing. This incompatible prescription management processing (FIG. 7) is automatically started at the time of start-up of the system and continues to operate until shutdown of the system.

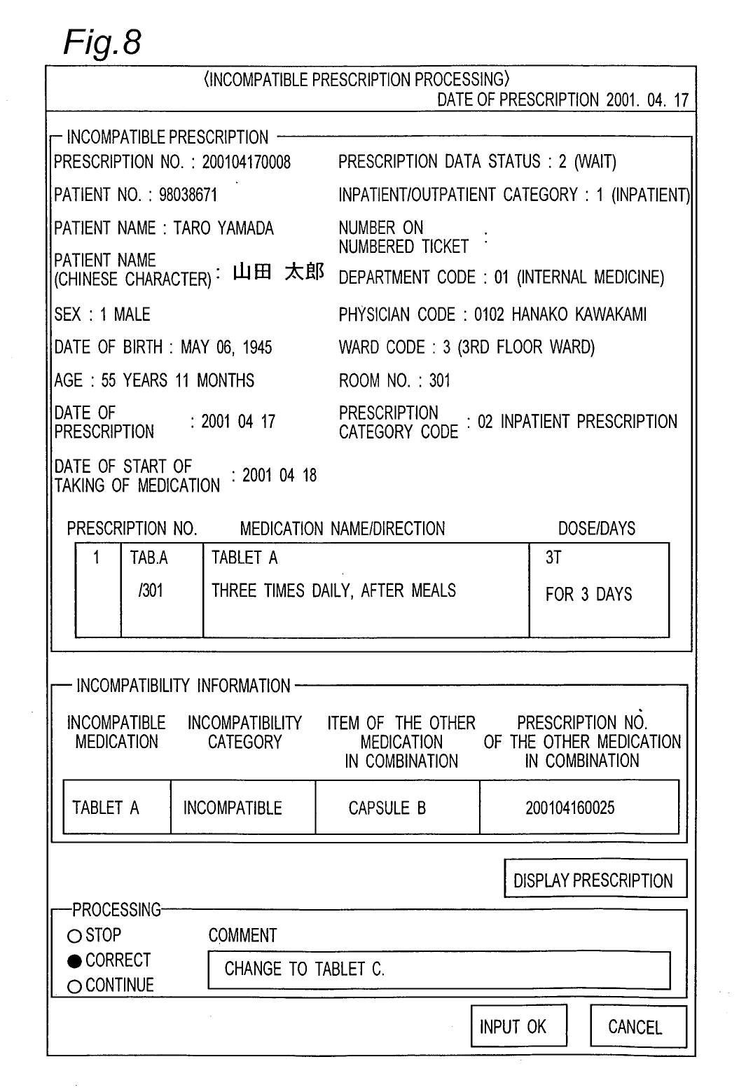

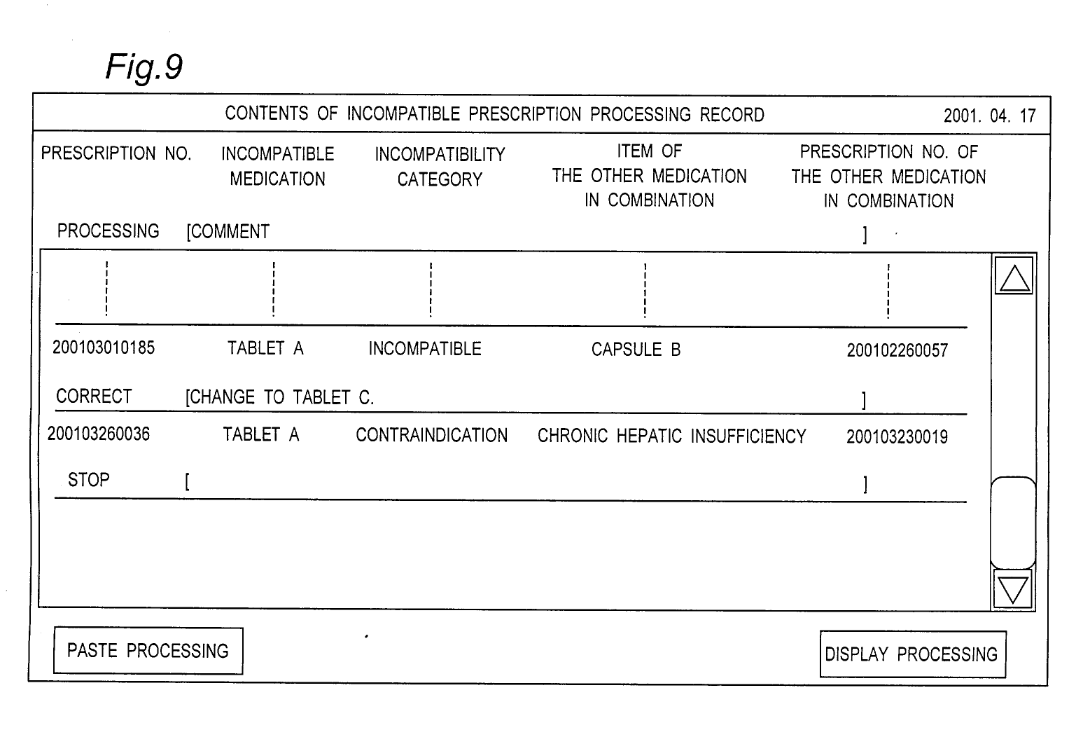

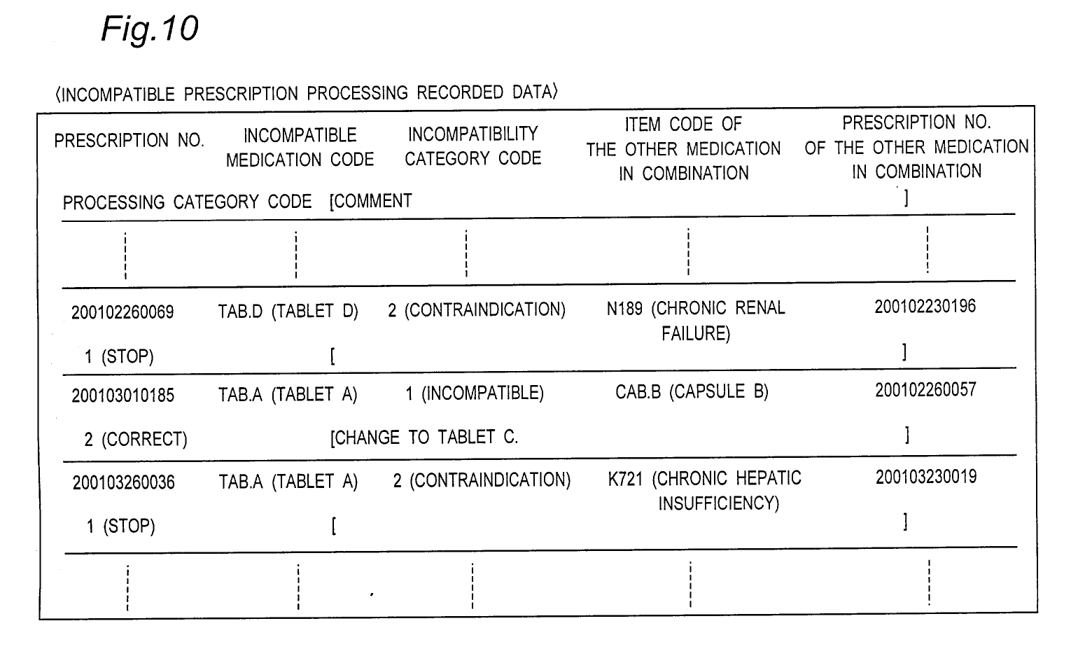

When an incompatible prescription message (FIG. 5), which is information of an incompatible prescription, is received from the dispensing control processing (FIG. 3) (step S21), information of the incompatible prescription is displayed on the screen of the incompatible prescription processing (FIG. 8) (step S22). On the screen shown in FIG. 8, contents of the prescription data of the incompatible prescription are displayed in an incompatible prescription column, and contents of the incompatibility data in the incompatible prescription are displayed in an incompatibility information column (step S23). When the prescription number of the other medication in combination in the incompatibility information column is selected and a “display prescription” button is clicked with a mouse, contents of prescription data of the other medication prescription are displayed in another window on the screen. Then, information about a past incompatible prescription processing record is acquired from incompatible prescription processing recorded data (FIG. 10) and displayed on a screen of recorded contents of incompatible prescription processing (FIG. 9). Since all incompatible prescription processing data is recorded in the incompatible prescription processing recorded data (FIG. 10), incompatible prescription processing data having the same incompatible medications is extracted and displayed. In an example shown in FIG. 9, information about incompatible prescription processing records where a tablet A is incompatible are displayed. On the screen shown in FIG. 9, when processing is selected from the incompatible prescription processing records and a “paste processing” button is clicked with a mouse, the processing and its comment are pasted in the processing column on the incompatible prescription processing screen (FIG. 8). Furthermore, when a prescription number is selected and a “prescription display” button is clicked with a mouse, contents of the prescription data of the prescription are displayed in another window on the screen.

Subsequently, the pharmacist inputs processing on the screen of the incompatible prescription processing (FIG. 8) (step S24). A selection button for stop, correct or continue in the processing column is clicked with a mouse, and a comment is inputted as required. Then, a processing message (FIG. 6) is sent to the dispensing control processing (FIG. 3) as information of the processing (step S25). Consequently, the processing of the incompatible prescription is executed according to the processing information. Furthermore, information about the incompatible prescription and its processing is recorded in the incompatible prescription processing recorded data (FIG. 10) (step S26).

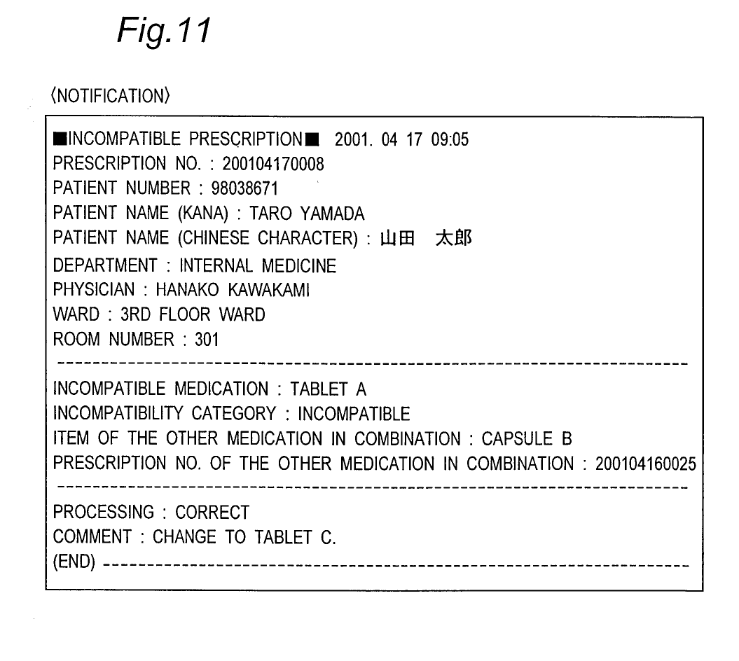

Here, whether the category of the prescription data (FIG. 4) is either inpatient or outpatient is judged (step S27). If the category is inpatient, information about the incompatible prescription and its processing (FIG. 11) is notified to a pharmacist in charge as a mail client 6 via a mail server 5 (step S28). The mail address or the like of the pharmacist in charge of the patient is acquired from the patient master. If the category is not inpatient, the category is outpatient. Therefore, the processing is repeated from the receiving of the incompatible prescription message. This may also be judged by the prescription category code of the prescription data (FIG. 4).

As evident from the above description, according to the present invention, since incompatible prescription data included in the prescription data is detected and the subsequent processing can be input automatically, dispensing processing can be smoothly proceeded, and the handling efficiency can be improved.

Although the present invention has been fully described by way of the examples with reference to the accompanying drawing, it is to be noted that various changes and modifications will be apparent to those skilled in the art. Therefore, unless such changes and modifications otherwise depart from the spirit and scope of the present invention, they should be construed as being included therein.

What is claimed is:

1. A dispensing control system capable of executing dispensing by controlling drive of various dispensing equipment based on prescription data, which includes:
a display means for displaying incompatible prescription data;
an input means for inputting processing of an incompatible prescription based on the incompatible prescription data displayed on the display means; and
control means for detecting whether the prescription data includes incompatible prescription data, allowing the detected incompatible prescription data to wait, displaying the data on the display means, and starting processing of the incompatible prescription inputted by the input means.

2. The dispensing control system according to claim 1, wherein, when the processing of the incompatible prescription is inputted by the input means, the control means allows the storage means to record the processing of the incompatible prescription.

3. The dispensing control system according to claim 1 or 2, wherein, when the processing of the incompatible prescription is inputted by the input means and a corresponding record is already in the storage means, the control means allows the display means to display the recorded contents.

4. The dispensing control system according to any one of claims 1 to 3, including a sending means for sending the incompatible prescription data, wherein
the control means judges whether the incompatible prescription is for an inpatient based on the prescription data, and allows the sending means to notify information about the incompatible prescription and its processing if the prescription is for an inpatient.
